(19) United States
(12) Patent Application Publication
(10) Pub. No.: US 2005/0079631 A1
(43) Pub. Date: Apr. 14, 2005

(54) Method and apparatus for ionization of a sample at atmospheric pressure using a laser

(75) Inventors: Victor V. Laiko, Ellicott City, MD (US); Vladimir M. Doroshenko, Ellicott City, MD (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Science & Engineering Services, Inc., Burtonsville, MD (US)

(21) Appl. No.: 10/681,198

(22) Filed: Oct. 9, 2003

(51) Int. Cl. G01N 24/00

(52) U.S. Cl. 436/173

(57) ABSTRACT

A method for ionizing a sample at ambient pressure including providing ionization-assisting molecules on a surface of a substrate, placing sample molecules on the surface of the substrate, and irradiating at least one of the sample molecules and the ionization-assisting molecules to produce ions of the sample molecules at or near atmospheric pressure. Accordingly, the system for ionizing sample molecules at or near atmospheric pressure is disclosed.

### CROSS-REFERENCE TO RELATED DOCUMENTS

This application is related to U.S. Patent Application Publication No. US2003/0052268 A1 entitled “Method and Apparatus for Mass Spectrometry Analysis of Common Analyte Solutions” filed Sep. 17, 2002, the entire contents of which are incorporated herein by reference.

### DISCUSSION OF THE BACKGROUND

1. Field of the Invention

The present invention relates to mass spectrometry and more specifically to the means of ionization of analyte ions under atmospheric pressure conditions using a laser.

2. Background of the Invention

An ion source represents an important part of any mass spectrometer. Among the more then twenty different types of ion sources that are known up to date, one particular group, i.e. atmospheric pressure (AP) ion sources, plays an increasingly important role for modern analytical applications of mass spectrometry. Atmospheric pressure ion sources produce ions outside a mass spectrometer vacuum housing under (or near) normal atmospheric pressure conditions. AP chemical ionization (CI) sources (see the review of Bruins et al., Mass Spectrom. Rev. 1991, 10, 53, the entire contents of which are incorporated herein by reference) produce ions of volatile analytes with molecular masses within the mass range ca. 1-150 Da. Electrospray ionization (ESI) widely used in modern analytical biochemistry (Yamashita et al., J. Chem. Phys. 1984, 88, 4451 and Fenn et al., Science 1989, 246, 64, the entire contents of which are incorporated herein by reference) can transfer heavy intact molecular ions (with masses of several hundred thousand Dalton) from a liquid analyte solution to a gas phase for a subsequent mass analysis. Atmospheric pressure matrix-assisted laser desorption/ionization (AP MALDI) sources (Laiko et al., U.S. Pat. No. 5,965,884, the entire contents of which are incorporated herein by reference) produce ions of heavy biomolecules under normal atmospheric pressure conditions by the influence of laser irradiation of analyte/matrix solid microcrystals.

AP ion sources have several important advantages over “internal” vacuum ion sources. First, because sample ionization takes place outside the MS instrument itself, all AP ion sources are more or less easily interchangeable. Potentially, the same instrument may be adopted for any of AP sources. Second, the gas/liquid/solid sample delivery or loading takes place under normal ambient atmospheric pressure condition.

Ions produced under atmospheric pressure by an AP ion source are introduced into the vacuum chamber of mass spectrometer through an atmospheric pressure interface (API). Typically, an API has several stages of differential pumping separated by several gas apertures. There are two main designs for the first inlet gas aperture of API. One introduced by Horning et al., Anal. Chem. 1973, 455, 936, the entire contents of which are incorporated herein by reference, includes a pinhole orifice in a thin membrane-type flange that separates the atmospheric pressure region and the first vacuum chamber of the MS instrument with the typical pressure of 0.1-5 mTorr. In another variation of API, see Whitehouse et al., Anal. Chem. 1985, 57, 675, the entire contents of which are incorporated herein by reference, the atmospheric pressure region is connected with an intermediate vacuum chamber (0.1-5 mTorr) through a transport capillary with the typical inner diameter of 0.1-1 mm. Typically, this capillary is heated to the temperature of 80-250° C. for an ion desolvation. One design of the heated capillary that delivers atmospheric pressure ions inside a vacuum chamber is described by Chait, et al. (U.S. Pat. Nos. 4,977,320 and 5,245,186, the entire contents of which are incorporated herein by reference). An API with a heated transport capillary has several advantages over the pinhole interface and is widely used in modern commercial and scientific MS instruments. The process of ion transport by viscous gas flow through capillaries has been investigated in some detail by B. Lin and J. Sunner in J. Am. Soc. Mass Spectrom. 1994, 5, 873-885, the entire contents of which are incorporated herein by reference.

In matrix assisted laser desorption ionization (MALDI), one of methods used for bioanalyte molecule ionization, special treatments of the sample are required for satisfactory atmospheric pressure ionization. Such treatments include steps of: purifying the analyte solution to remove buffer salts, mixing the analyte solution with a matrix solution, and/or depositing and drying the combined mixture on a surface (to be laser irradiated). As a result, MALDI analysis is usually made in an off-line mode and requires special equipment for treatment and handling of samples.

In vacuum MALDI, laser desorption and ionization takes place inside a vacuum chamber under vacuum conditions. See e.g., Karas et al., Anal. Chem. 1988, vol. 60, pp. 2299-2301, the entire contents of which are incorporated herein by reference. A target is prepared by mixing a solution of analyte molecules with a specially chosen material known as a matrix, usually an organic acid in the form of solid crystals. The analyte-matrix solution is then dried on a target plate to form a solid matrix material with incorporated analyte molecules. The target plate is irradiated in vacuum with a UV or IR laser pulses. The matrix material absorbs the radiation, and a plume of hot matrix molecules lifts the analyte molecules into the gas phase.

In AP MALDI, an analyte sample, such as the aforementioned solid analyte and matrix resides outside the vacuum system, and irradiation of the matrix material creates hot plume similar to vacuum MALDI with the analyte molecules liberated into a region near an API. The AP MALDI ion source is interchangeable with electrospray ionization sources. See e.g., U.S. Pat. No. 5,965,884; the entire contents of which are incorporated herein by reference. The same mass spectrometer instrument can be used for both Electrospray and AP MALDI measurements. AP MALDI is a softer ionization technique as compared to vacuum MALDI. Ions produced by AP MALDI under atmospheric pressure conditions are quickly cooled by the ambient gas before thermal fragmentation can take place. See e.g., Laiko et al., “Atmospheric Pressure Matrix-Assisted Laser Desorption/Ionization Mass Spectrometry”, Analytical Chemistry, Vol. 72, No.4, Feb. 15, 2000, pp. 652-657; Laiko et al., “Atmospheric Pressure MALDI/Ion Trap Mass Spectrometry”, Analytical Chemistry, vol. 72, No. 21, 2000, pp. 5239-5243, the entire contents of which are incorporated herein by reference.

Doroshenko et al. describe in U.S. patent application Ser. No. 09/953,403, the entire contents of which are incorporated herein by reference, an atmospheric pressure laser-assisted desorption/ionization (AP-LADI) technique in which sample molecules are analyzed directly from a liquid solution. In this method, laser energy is absorbed by solvent molecules in contrast to specially added matrix molecules as in AP-MALDI method. The AP-LADI method is specifically designed for ionization and subsequent mass spectrometric analysis of samples in a liquid phase.

Siuzdak et al. in U.S. Pat. No. 6,288,390, the entire contents of which are incorporated herein by reference, and Wei et al. in Nature, vol. 401, 1999, p. 243, the entire contents of which are incorporated herein by reference, both describe a matrix-free laser desorption/ionization technique utilizing a surface of porous silicon (DIOS). This approach utilizes target plates that are etched in a special way from silicon to obtain a highly porous surface. The structure of the porous silicon retains solvent and analyte molecules that together with the UV absorptivity of the silicon substrate accounts for transfer of the laser energy and electric charge to the analyte. Laiko et al. in “Atmospheric Pressure Laser Desorption/Ionization On Porous Silicon”, Rapid Commun. Mass Spectrom., vol. 16, 2002, p. 1737-1742, the entire contents of which are incorporated herein by reference, report on demonstration of this method at the atmospheric conditions.

Hutchens et al. in U.S. Pat. No. 5,719,060, the entire contents of which are incorporated herein by reference, describe a probe surface that is derivatized with appropriate density of energy absorbing molecules bonded (covalently or non-covalently) to the surface in a variety of absorbing geometries such as a monolayer or multiple layers of attached energy absorbing molecules. By absorbing the laser energy, these immobilized energy absorbing molecules facilitate the desorption and subsequent ionization of analyte molecules attached to the energy absorbing molecules. This method as described therein requires capturing analyte molecules on a probe surface using molecular affinity (selective or non-selective) techniques and introducing the probe into a vacuum ambient for laser desorption ionization. Ion losses commonly observed in the case of AP ion sources during the ion transfer from the source into the mass spectrometer are avoided by the vacuum ionization process of Hutchens et al., but at a cost and complexity of introducing the probe surface into the vacuum mass spectrometer.

### SUMMARY OF THE INVENTION

One object of the present invention is to provide a method and apparatus for ionization of biomolecules at ambient atmospheric pressure conditions.

Another object of the present invention is to provide a method and apparatus for ionization of analyte biomolecules at atmospheric pressure conditions without pre-mixing the analyte sample with ionization-assisting matrix molecules.

Still a further object of the present invention is to provide a method and apparatus for laser ionization of analyte biomolecules directly from chemically derivatized (covalently or non-covalently) probe surfaces at atmospheric pressure conditions.

Various of these and other objects of the present invention are accomplished in several embodiments of the present invention. In one exemplary embodiment of the present invention, a surface of a substrate is provided with ionization-assisting molecules. Sample molecules are placed on the surface. The sample molecules and/or the ionization-assisting molecules are irradiated to produce ions of the sample molecules at or near atmospheric pressure conditions. Accordingly, one exemplary embodiment of the present invention includes a system for ionizing sample molecules. The system includes a substrate provided with ionization-assisting molecules having placed thereon sample molecules for ionization and includes an irradiating device to irradiate the sample molecules and/or the ionization-assisting molecules to produce ions of the sample molecules at or near atmospheric pressure.

In one aspect of the present invention, sample or analyte ions, preferably ions of biopolymer molecules, are produced at normal atmospheric pressure directly from probe surfaces chemically derivatized (covalently or non-covalently) with ionization-assisted molecules by irradiating the surface containing analyte molecules by a pulsed laser at an absorption wavelength of the ionization-assisted molecules. The derivatization of the surface can be done in a variety of absorbing geometries involving monolayer or multiple layers of attached ionization-assisting molecules.

In another aspect of the present invention, the ionization-assisting molecules function to facilitate absorption of the laser energy and transfer of electric charge to the sample or analyte molecules. Analyte molecular ions produced near the surface of the probe are directed toward an atmospheric pressure inlet hole by air/gas flow and/or an electric field, and collected for subsequent mass analysis by a mass spectrometer.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1 is a schematic view of AP-SALDI ion source, according to the present invention, interfaced with a LCQ ion trap mass spectrometer;

FIGS. 2A-2E are mass spectra taken from of various peptides using the AP-SALDI ion source of the present invention; and

FIG. 3 is a flow chart illustrating one method of the present invention.

### DETAILED DESCRIPTION OF THE PREFERRED EMBODIMENTS

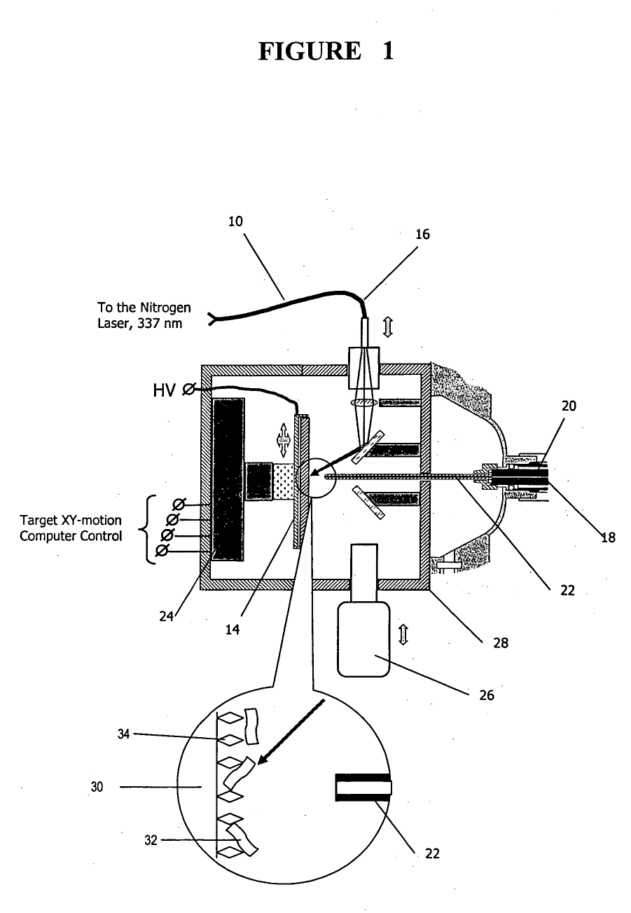

Referring now to the drawings, wherein like reference numerals designate identical, or corresponding parts throughout the several views, and more particularly to FIG. 1 thereof, FIG. 1 depicts an illustrative schematic view of atmospheric pressure surface assisted laser desorption ionization (AP-SALDI) ion source 10 of the present invention. The AP-SALDI ion source 10, for example, can be based on a commercially available Model AP/MALDI-111 source from MassTech Inc. (Columbia, Md.) interfaced with an LCQ™ ion trap mass spectrometer from Thermo Finnigan (San Jose, Calif.). The AP-SALDI ion 10 source of the present invention includes a target plate 14.

The target plate 14, in one preferred embodiment of the present invention, is irradiated with a UV laser beam (337 nm wavelength) delivered for example via an optical fiber 16. The laser beam is focused onto the target plate using conventional optical techniques. The size of the target plate 14 may not readily permit the placement of AP-SALDI ion source 10 in close proximity with an inlet orifice 18 to a capillary 20 connecting to the mass spectrometer. The inlet orifice 18 and the capillary 20 separate atmospheric pressure from a vacuum region of the mass spectrometer. The capillary 20, in one embodiment of the present invention, can be a heated capillary as known in the art.

To accommodate collection of ions from the atmospheric pressure desorption/ionization event, in one embodiment of the present invention, the capillary 20 is connected to an extended capillary 22 (e.g., with an i.d. of 0.3-1.0 mm typically). The extended capillary 22 accommodates, by a two-dimensional x-y stage 24, close positioning of the target plate 14 to a tip of the extended capillary 22. The tip of the extended capillary can be located for example at the distance of 1.0-2.0 mm from the target plate 14. A plane position of the target plate 14 relative to the extended capillary 22 is controlled via the x-y stage 24, such as for example a motorized stage using a computer (not shown). As such, the target plate 14 can be moved in a continuous spiral, or any other programmed, motion for supplying fresh sample positions for the laser pulses. A camera 26 (e.g., a CCD camera) is preferably attached to housing 28 of the AD-SALDI ion source 10 for monitoring the sample positioning and desorption process. The housing 28 can be filled for example with a dry gas (e.g., nitrogen) to decrease ion losses via the ion-molecule reactions.

Samples 30 for ionization, in one exemplary embodiment of the present invention, can be located on the target plate 14 at multiple spot locations, e.g. up to 96 spot locations. A voltage of 0.5-2.5 kV is typically applied between the target plate 14 and the extended capillary 22 to facilitate migration of ions toward the tip of the extended capillary 22. A pressure drop inside the capillary system (i.e., the capillary 20 and the extended capillary 22 between the atmosphere and vacuum housing of a mass spectrometer) serves to produce a gas flow into the mass spectrometer that entrains ions in the gas flow.

According to one embodiment of the present invention, a laser pulse of a 1.0-10.0 ns duration is used to desorb and ionize sample (i.e. analyte) molecules 32. Longer or shorter pulses can be used. Each laser pulse preferably has a sufficient laser fluence to produce ionization (e.g., 50-200 μJ/pulse energy concentrated to an elliptical spot of 400×600 μm size).

According to one embodiment of the present invention, a frequency of laser pulse repetition can be in a range of 5-10 Hz, but the frequency can be lower or higher.

Surface preparation methods applicable to the present invention are similar to those described in U.S. Pat. No. 5,719,060, the entire contents of which are incorporated herein by reference. In U.S. Pat. No. 5,719,060, a method referred to as Surface Enhanced Neat Desorption (SEND) is used to derivative an appropriate density of energy absorbing molecules which in turn are vacuum laser ionized. In the present invention, similar methods such as SEND provide ionization-assisting molecules 34 bonded covalently or non-covalently to the target surface in a variety of geometries including both monolayer and/or multiple layer structures.

For example, ionization-assisting molecules such as for example α-cyano-4-hydroxycinnamic acid (CHCA) ionization-assisting molecules can be derivitized on the target or probe surface. CHCA molecules are suitable atmospheric pressure ionization assisting molecules. One procedure of the present invention involves, for example: dissolving CHCA in methanol mixed with gels such as for example Affigel 10 and Affigel 15 (BioRad, Hercules, Calif.) for adsorption at various pH at 23° C. for 2-24 hours, washing access CHCA molecules away by methanol, and placing the gel absorbed CHCA molecules on an atmospheric probe.

Other procedures of the present invention involve the derivitization of surfaces with ionization-assisting molecules, such as for example Dihydrobensoic acid, Cinnamamide, and Cinnamyl bromide which are not known to produce ions in the above-noted MALDI process. These molecules like the above-noted CHCA molecules absorb light and facilitate ion production. Derivitization of surfaces such as for example polymers is described in U.S. Pat. No. 5,995,562, the entire contents of which are incorporated by reference.

In addition to having ionization-assisting molecules covalently bound to the surface, as described above, other procedures for co-ordinate covalent bonds, ionic bonds, and hydrophobic/Van der Waals bonds are also applicable according to the present invention to produce surfaces bonding the ionization-assisting molecules for subsequent atmospheric pressure desorption/ionization. For example, the target surfaces can contain chemically defined and/or biologically defined affinity capture centers to facilitate either the specific or nonspecific attachment or adsorption of ionization-assisting molecules to a target surface, by a variety of mechanisms (mostly noncovalent). The target surface can contain one or more types of chemically defined crosslinking molecules. For example, photolabile attachment molecules (PAM) which are bivalent or multivalent in character can be used to attach ionization-assisting molecules to the target or probe surfaces.

In one demonstration of the present invention, a commercial LC-MALDI prep™ Target (P/N 186001504) from Waters Corporation (Milford, Mass.) was used as a SALDI substrate (i.e. substrate 30). The substrate from Waters Corporation (and other such similar targets) is made in the form of thin aluminum foil (i.e. a target foil). One side of the foil attaches to a probe or to a target surface thereon, and the other side of the foil is processed to contain ionization-assisting molecules thereon, such as for example CHCA. While CHCA molecules are widely used as a matrix in conventional MALDI sample preparation, in MALDI, the analyte molecules are incorporated into CHCA crystals formed after controlled drying of an analyte solution containing a majority of CHCA molecules. In the present invention, the target foil (i.e. substrate 30) can be used to directly collect liquid sample effluent from a liquid source such as for example effluent from high pressure liquid chromatograph (HPLC) and thereafter can be used to analyze the collected effluent by SALDI of the present invention.

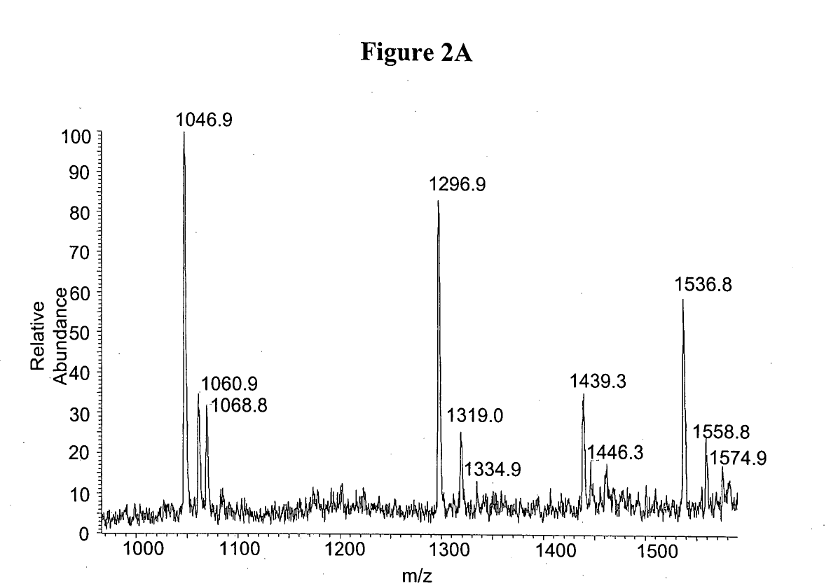

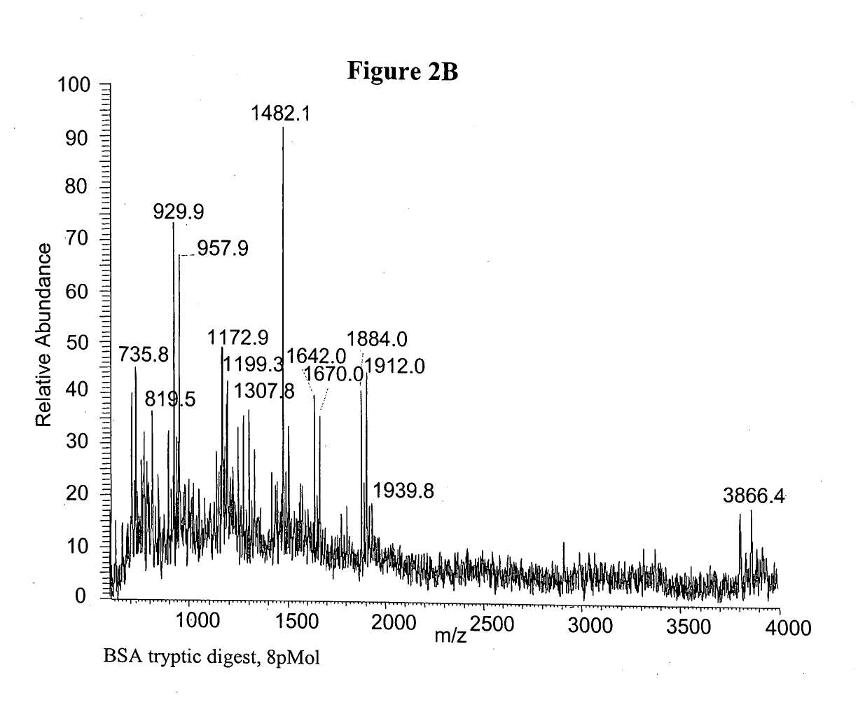

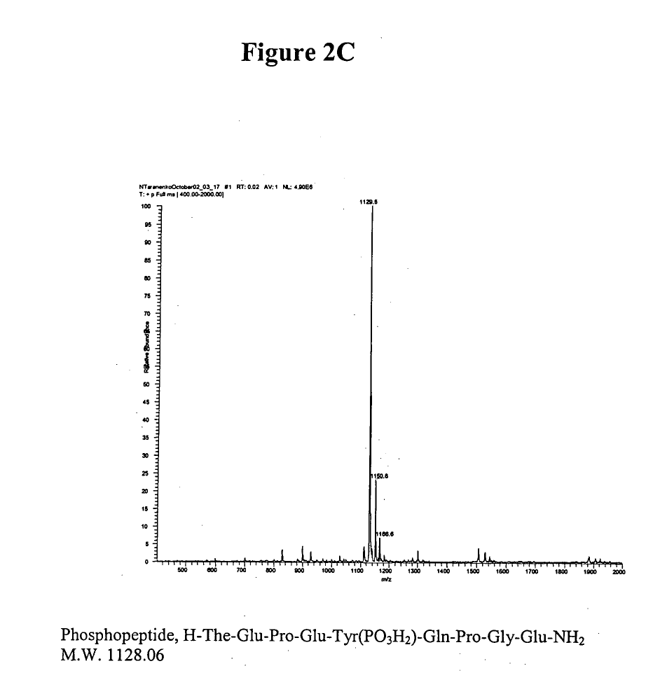

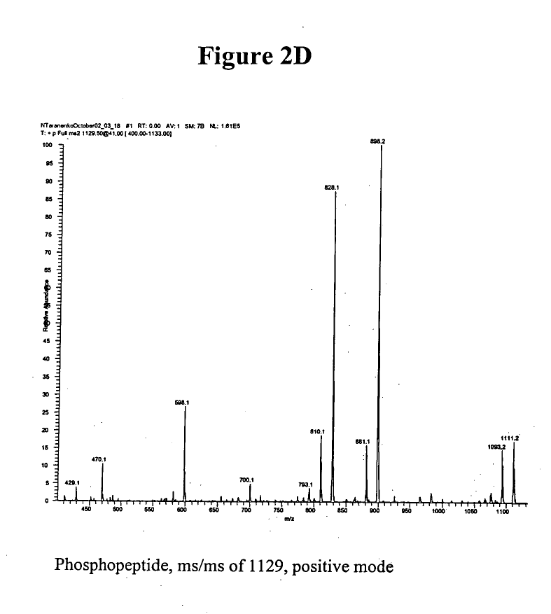

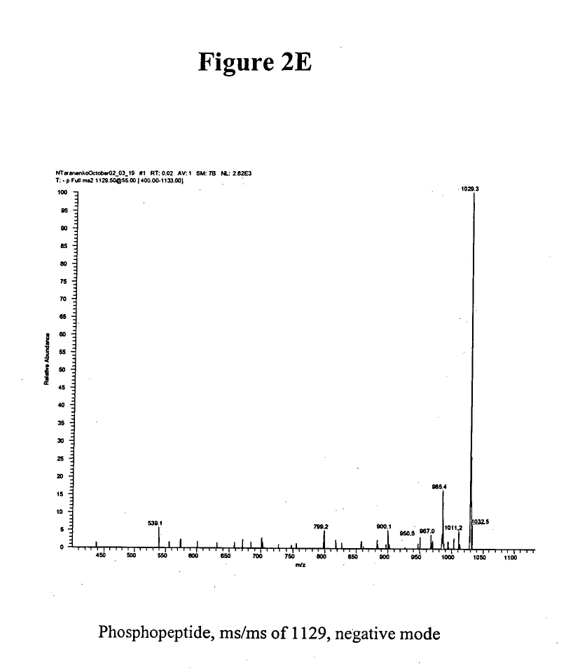

In this example, the target foil with a CHCA layer applied was attached to a AP/MALDI target plate and a droplet of an analyte solution in water containing 0.1% trifluoroacetic acid (TFA) was placed on the treated foil. (CHCA is insoluble in water.) As a result, this sample of analyte was prepared without mixing analyte molecules with matrix molecules as normally required in a MALDI procedure. The mass spectrum of mixtures of four peptides (purchased from Sigma, St. Louis, Mo.) prepared on the target foil using the above-described technique is shown in FIG. 2A as demonstration of the present invention. Mass spectra from other peptides are shown in FIGS. 2B-2E.

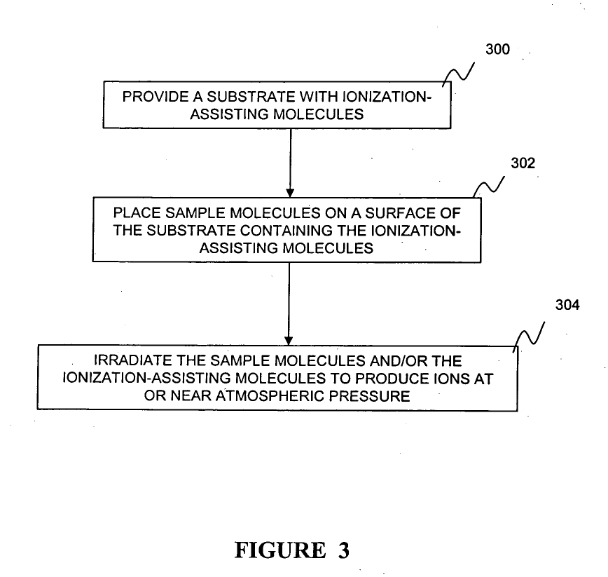

FIG. 3 depicts a flowchart illustrating the present invention in which sample molecules from a substrate are ionized at or near atmospheric pressures.

In step 300, a surface of the substrate is provided with ionization-assisting molecules. As noted earlier, ionization-assisting molecules as used in the present invention are molecules which (i) absorb light and (ii) facilitate analyte ion production. While the present invention is not bound to a particular theory, the ionization assisting molecules facilitate charge transfer mechanisms to the analyte molecules. Ionization-assisting molecules such as for example α-cyano-4-hydroxycinnamic acid, dihydrobensoic acid, cinapinic acid, formic acid, succinic acid, picolinic acid, and 3-hydroxy-picolinic acid can be attached to the surface. The ionization-assisting molecules are preferably absorbent at a wavelength of the laser to thereby enhance sample ionization. In step 300, the substrate provided with the ionization-assisting molecules can be a porous substrate. In step 300, the substrate can be a gel, and more specifically can be a polyacrylamide gel. More generally, the substrate can be made of a glass, ceramic, Teflon coated magnetic material, organic materials, and native biopolymers. The surface of the substrate can be modified by a derivitization which bonds the ionization-assisting molecules covalently or non-covalently to the surface. Accordingly, a monolayer and/or multiple layers of the ionization-assisting molecules can be attached to the substrate surface. Further, the surface can be provided by attaching the ionization-assisting molecules to the surface such that the ionization-assisting molecules are immobilized on the surface. As used herein, for the ionization-assisting molecules to be immobilized on the surface means that the ionization-assisting molecules are fixed in a position on the surface which on average would not change position with time.

In step 302, sample molecules are placed on the surface. The sample molecules ionized in the present invention include, but are not limited to, organic and inorganic molecules, and biopolymers such as peptides, proteins, ribonucleic acid (RNA), deoxyribonucleic acids (DNA), and carbohydrates (CHO). In one embodiment, the sample molecules can be placed on the surface by depositing the sample molecules (dissolved in a solvent) on the surface and then evaporating the solvent to thereby dry the sample molecules onto the surface. Further, sample molecules can be considered to be placed on the surface by attaching of the sample molecules to the surface using affinity techniques to adhere the sample molecules to the ionization assisting molecules. As placed, the sample molecules can be adjacent the ionization-assisting molecules.

In step 304, the sample molecules and/or the ionization-assisting molecules are irradiated to produce ions at or near atmospheric pressure conditions. As used herein, at or near atmospheric pressure refers to conditions typically at a pressure range from 1-1000 Torr. In step 304, the sample molecules and/or the ionization-assisting molecules can be irradiated with a laser. For example, the sample molecules can be irradiated with a pulsed laser having a laser pulse duration within 1-100 nsec or irradiated with a continuous laser. The laser wavelength is preferably at least one of about 266 nm, 337 nm, 355 nm, or 3 μm. For these wavelengths, the following are non-limiting examples of ionization-assisting molecules with preferred ranges of wavelength for each of these listed in parentheses: Nicotinic acid (266 nm, 3 μm), α-cyano-4-hydroxycinnamic acid, dihydrobensoic acid (337 nm, 3 μm), cinapinic acid (337 nm, 3 μm), succinic acid (3 μm), picolinic acid (337 nm, 3 μm), and 3-hydroxy-picolinic acid (337 nm, 3 μm).

Once the ions are produced in step 306, the produced ions can be transported toward an inlet orifice of a mass spectrometer (e.g., toward a tip of the extended capillary 22 shown in FIG. 1). The transporting can occur by drifting the ions toward an orifice of a mass spectrometer with an electric field and/or by entraining the ions in a gas flowing into an orifice of the mass spectrometer.

Accordingly, there are several features that may serve to distinguish the present invention from previous ionization techniques. For instance, ionization takes place at normal atmospheric pressure in the present invention not in a vacuum ambient as described in U.S. Pat. No. 5,719,060. Further, analyte molecules are captured on the surface of a substrate in the present invention using for example molecular affinity (selective or non-selective) techniques, thus exposing the analyte molecules directly to the laser irradiation without having the analyte molecules diluted in an exogenous matrix, as in AP-MALDI.

Numerous modifications and variations of the present invention are possible in light of the above teachings. It is therefore to be understood that within the scope of the appended claims, the invention may be practiced otherwise than as specifically described herein.

1. A method for ionizing sample molecules from a substrate, comprising:
providing on a surface of said substrate ionization-assisting molecules;
placing sample molecules on said surface; and
irradiating at least one of the sample molecules and the ionization-assisting molecules to produce ions of said sample molecules at or near atmospheric pressure.

2. The method as in claim 1, wherein the step of providing comprises:
using as said substrate a porous substrate.

3. The method as in claim 1, wherein the step of providing comprises:
using as said substrate a gel.

4. The method as in claim 1, wherein the step of providing comprises:
using as said substrate a polyacrylamide gel.

5. The method as in claim 1, wherein the step of providing comprises:
modifying said surface by a derivitization that bonds said ionization-assisting molecules covalently to said surface.

6. The method as in claim 1, wherein the step of providing comprises:
modifying said surface by a derivitization that bonds said ionization-assisting molecules non-covalently to said surface.

7. The method as in claim 1, wherein the step of providing comprises:
attaching a monolayer of said ionization-assisting molecules to said surface.

8. The method as in claim 1, wherein the step of providing comprises:
attaching multiple layers of said ionization-assisting molecules to said surface.

9. The method as in claim 1, wherein the step of providing comprises:
attaching said ionization-assisting molecules to said surface such that said ionization-assisting molecules are immobilized on said surface.

10. The method as in claim 1, wherein the step of providing comprises:
attaching at least one of α-cyano-4-hydroxycinnamic acid, dihydrobensoic acid, cinapinic acid, nicotinic acid, succinic acid, picolinic acid, and 3-hydroxy-picolinic acid to said surface.

11. The method as in claim 1, wherein the step of providing comprises:
attaching said ionization-assisting molecules that absorb at a wavelength of said laser.

12. The method as in claim 1, wherein the step of placing comprises:
depositing the sample molecules dissolved in at least one solvent; and
evaporating said at least one solvent.

13. The method as in claim 1, wherein the step of placing comprises:
attaching of said sample molecules to said surface using affinity techniques.

14. The method as in claim 1, wherein the step of placing comprises:
placing as said sample molecules at least one of peptides, proteins, ribonucleic acid, deoxyribonucleic acids, and carbohydrates.

15. The method as in claim 1, wherein the step of irradiating comprises:
irradiating with a pulsed laser.

16. The method as in claim 14, wherein the step of irradiating with a pulsed laser comprises:
irradiating with a laser pulse duration with a range of 1-100 nsec.

17. The method as in claim 1, wherein the step of irradiating comprises:
irradiating with a continuous laser.

18. The method as in claim 1, wherein the step of irradiating comprises:
irradiating with a laser of a wavelength of at least one of about 266 nm, 337 nm, 355 nm, or 3 μm.

19. The method as in claim 1, wherein the step of irradiating comprises:
irradiating with a laser of a range of 50-200 μJ/pulse energy.

20. The method as in claim 18, wherein the step of irradiating comprises:
irradiating with a laser concentrated to an elliptical spot of 400×600 μm.

21. The method as in claim 1, further comprising:
transporting said ions toward an inlet orifice of a mass spectrometer.

22. The method as in claim 20, wherein said transporting comprises:
drifting said ions toward the inlet orifice of the mass spectrometer by an electric field.

23. The method as in claim 21, wherein said transporting comprises:
entraining said ions in a gas flowing into said mass spectrometer via said orifice.

24. A system for ionizing sample molecules, comprising:
a substrate;
ionization-assisting molecules on said substrate;
said sample molecules adjacent said ionization-assisting molecules; and
an irradiating device configured to irradiate at or near atmospheric pressure at least one of the sample molecules and the ionization-assisting molecules.

25. The system of claim 24, wherein said substrate comprises:
a porous substrate.

26. The system of claim 24, wherein said substrate comprises:
a gel.

27. The system of claim 24, wherein said substrate comprises:
a polyacrylamide gel.

28. The system of claim 24, wherein said substrate comprises:
a derivitized surface that bonds said ionization-assisting molecules covalently to said surface.

29. The system of claim 24, wherein said substrate comprises:
a derivitized surface that bonds said ionization-assisting molecules non-covalently to said substrate.

30. The system of claim 24, wherein said substrate comprises:
a monolayer of said ionization-assisting molecules attached to a surface of said substrate.

31. The system of claim 24, wherein said substrate comprises:
multiple layers of said ionization-assisting molecules attached to a surface of said surface.

32. The system of claim 24, wherein said substrate comprises:
an immobilized surface of said ionization-assisting molecules attached to a surface of said substrate.

33. The system of claim 24, wherein said substrate comprises:
a layer of at least one of α-cyano-4-hydroxycinnamic acid, dihydrobensoic acid, cinapinic acid, nicotinic acid, succinic acid, picolinic acid, and 3-hydroxy-picolinic acid attached to a surface of said surface as said ionization-assisting molecules.

34. The system of claim 24, wherein said irradiating device comprises:
a pulsed laser.

35. The system of claim 24, wherein said irradiating device comprises:
a laser pulse duration with a range of 1-100 nsec.

36. The system of claim 24, wherein said irradiating device comprises:
a continuous laser.

37. The system of claim 24, wherein said irradiating device comprises:
a laser of a wavelength of at least one of about 266 nm, 337 nm, 355 nm, or 3 μm.

38. The system of claim 24, wherein said irradiating device comprises:
a laser having a range of 50-200 μJ/pulse energy.

39. The system of claim 38, wherein said irradiating device is configured to irradiate an elliptical spot of 400×600 μm.

40. The system of claim 24, further comprising:
a mass spectrometer having an orifice to collect said ions for mass analysis.

41. The system of claim 40, further comprising:
a housing enclosing the substrate and providing a gas purge to a region of the substrate and the mass spectrometer.

42. The system of claim 24, wherein said sample molecules comprise at least one of peptides, proteins, ribonucleic acid, deoxyribonucleic acids, and carbohydrates.
